(19) United States
(12) Patent Application Publication
(10) Pub. No.: US 2011/0174166 A1
(43) Pub. Date: Jul. 21, 2011

(54) Chocolate crafting system

(76) Inventors: Tara Sparacio, Commack, NY (US); Karen Levy, Commack, NY (US)

(21) Appl. No.: 12/657,395

(22) Filed: Jan. 20, 2010

(51) Int. Cl. A23G 1/30; H05B 3/02; H05B 1/02; B65D 85/00; B65D 21/02; B65D 37/00

(52) U.S. Cl. 99/453; 219/386; 219/428; 219/494; 219/492; 206/372; 220/23.88; 222/206

(57) ABSTRACT

A transportable chocolate crafting system a casing box in which is arranged a plurality of heating compartments, wherein each of the heating compartments are configured to receive one of a plurality of containers that hold a quantity of chocolate. The containers are separately heated by a plurality of electrically-powered heating units, to melt the quantity of chocolate and to maintain the melted chocolate in a molten, flow able state. A control system or master controller detects a presence of a container in a heating compartment, detects a quantity of chocolate in the container, monitors a temperature of the chocolate in the container and controls an application of heat to the heating unit in the heating compartment in which the detected container is present, based on a calculated desired chocolate state and a calculated temperature gradient.

### FIELD OF THE INVENTION

The present invention relates to chocolate broadly and, more particularly relates to a transportable chocolate crafting system including a casing with storage compartments and a chocolate working compartment for containing a plurality of separate chocolate containers and maintain each container within a particular temperature range to maintain chocolate contained therein in a molten, flowable state.

### BACKGROUND OF THE INVENTION

Techniques for processing pure chocolate into chocolate candies have been taught in industry for some time.

For example, U.S. Pat. No. 3,115,821 of Hubner discloses a machine for treating bulk chocolate masses. The machine comprises a cylindrical container, a central shaft extending into the container with at least one scraper for engaging the inner container surface to mix the chocolate as it is melted.

U.S. Pat. No. 3,756,141 of Rose discloses an apparatus for controllably melting and tempering chocolate. The patent describes that in order to present a proper appearance, chocolate must be properly tempered and that if used as a coating while not properly tempered (for example, in crafts), the chocolate will streak and turn white due to the fats and oils separating from the chocolate mass. In the past, chocolate mills consisted of several pieces of machinery such as double boilers for melting and tempering chocolate and warming or candy rolling tables which are used by the confectioners to keep the chocolate in a warm and molten condition during the candy making process.

More particularly, the tempering of natural chocolate generally has been accomplished by grating or cutting the chocolate into small pieces and heating at a temperature of 100 degrees F. such as in a double boiler while stirring to melt completely. The melted chocolate is then reduced in temperature to a temperature between 60 and 80 degrees F. and finally the temperature of the melt is raised to approximately 85 degrees F. for use in the various candy making processes. The process must be conducted with extreme care to prevent any moisture from the double boiler getting into the chocolate or the temperature from rising above 100 degrees F. as either will cause the chocolate to change color and be unfit for use as a candy coating.

U.S. Pat. No. 7,231,872 of Babicz discloses a chocolate tempering machine that is digitally programmable for controlling the heating, cooling and rotation of chocolate being processed in a cylindrical container. The machine is program-controlled to enable agitated, liquid chocolate to retain its proper viscosity for extended periods of time. The machine includes a menu program, whereby a user can adjust and save up to twenty-six different temperature menus or more. This menu program can also be accessed to set and save desired cool down temperatures. Sensors are located such that ambient air and relative humidity can be sensed and audio/visual warnings are provided to the user when these conditions must be altered. A visual feedback real-time clock display is provided to the user corresponding to a specific timed software function.

Such chocolate processing machines are typically not available to the home consumer due in part to the high cost, large size, and required expertise in the use of such equipment. However, interest in chocolate world-wide has intensified over the past 20 or 30 years, probably partly as a result of the emergence and success of the so-called gourmet chocolate shops and store boutiques. A great many people around the world love chocolate.

U.S. Pat. Nos. 4,706,558 of Snyder and 4,907,502, also of Snyder, disclose home chocolate processing apparatus that enable an ability to produce very high quality pure chocolate candies in the home. These apparatus account for the fact that pure chocolate, which is made up of pure cocoa, cocoa butter and sugars, as major ingredients, requires carefully temperature and moisture controlled processing. In more detail, pure chocolate used in the production of chocolate candies is referred to as “coating” in the industry and has two crystal states, tempered and untempered. The desired state is the production of tempered coatings, but in order to produce them, the temperature and agitation of the coating must be maintained within very narrow limits.

Typically, in a known method, a coating is introduced into a vat where it is stirred while the coating is allowed to reach gently the initial melting temperature. The coating is then allowed to drop to some lower temperature and then brought up to some intermediate temperature for final processing into candy. These temperatures are normally held to well within one degree F. The coating is gently agitated during the heating-cooling cycle and such agitation continues during the processing cycle.

It becomes obvious that if one is to attempt to carry out these processing steps in the home, via the use of a double boiler, stove, microwave oven, the results would be spotty at best, and a poor quality product would be almost always produced. Because of this, pure, high quality coatings are not offered to the consumer for home processing. Materials available through specialty shops for the making of home-made chocolates are of generally poor quality because they are not pure coatings.

The home chocolate processing apparatus comprises a bowl configured to accommodate a coating, which bowl is removably mounted in a casing. A moving device in the casing is coupled to the bowl for rotating said bowl. A heater is positioned in the casing in operative proximity with the bowl for melting the chocolate. A cooling unit is positioned in the casing in operative proximity with the bowl for cooling the coating. A control circuit is electrically connected to the heater and cooling unit for controlling the heating and cooling of the coating.

While such apparatus are ideal for melting and maintaining a mass of chocolate, for example, for use as a coating (pure chocolate), the apparatus are not for use in crafts sets, where it is desirable to melt and use small amounts of chocolate, segregating these small amounts in different containers that might include dyeing to change colors.

### SUMMARY OF THE INVENTION

A chocolate crafting system that overcomes the shortcomings of known chocolate crafting systems is disclosed and presented hereby.

In one embodiment, the inventive portable chocolate crafting system is arranged in a casing. The casing is configured with a plurality of semi-enclosed (heating) compartments that are open at the top for receiving and holding one of a plurality of containers, the containers arranged for holding and dispensing a quantity of chocolate.

A plurality of electrically-powered heating units is operatively arranged within each one of the plurality of semi-enclosed heating compartments in the casing. The heating units heat the compartments thereby heating containers positioned therein in order heat, melt and maintain the quantity of chocolate contained in respective containers in a molten, flowable state.

A control system (or master controller) detects a presence of a container in a semi-enclosed heating compartment, detects a quantity of chocolate in the container, monitors a temperature of the chocolate in the container and controls an application of heat to the heating unit at the semi-enclosed heating compartment in which the detected container is present based on the presence, the detected weight, and therefore, a calculated temperature gradient and chocolate state. Preferably, the semi-enclosed heating compartments are heat-insulated from one another.

The chocolate crafting system includes that the heating units include a sensor located at each semi-enclosed heating compartment for sensing the presence of a container therein and a temperature sensor for sensing a temperature of the chocolate present in the container therein. A weight sensor is preferably located at each semi-enclosed heating compartment for detecting an amount of chocolate in a container therein. The control system includes a timer for tracking a time during which heat is applied to each heating unit within each semi-enclosed heating compartment.

The control system, based on a detected weight and temperature of chocolate present in a container within a semi-enclosed heating compartment, controls an amount of electrical power delivered to the associated heating unit. Preferably, the control system maintains a record of detected temperatures and weights of chocolate present in the container within the heating compartment over time, calculates a temperature gradient based thereon, and controls an amount of electrical power delivered to the associated heating unit to either effectively melt the chocolate or, if already in a melted state, to effectively maintain the chocolate in said melted state.

The chocolate crafting system preferably includes display device and a data input device, e.g., a keyboard, and the control system includes a microcontroller and a memory-storage device. The memory-storage device includes a set of computer readable instructions that are operated upon by the microcontroller to implement a plurality of control functions. The control system preferably controls an alarm signal output in response to detecting 1) that chocolate in a container is too hot and 2) that an amount of chocolate in a container is less than a recommended amount, or any other detectable operating state, without limitation.

The chocolate crafting system includes an electrical power source for powering the control system and heating units. The electrical power source may be a DC battery pack, or may merely be an AC to DC transformer, that when connected to an AC power source, converts AC to DC at an appropriate regulated power level conducive to system operation.

The casing is constructed to include a compartment, preferably insulated, within which the plurality of semi-enclosed heating compartments is arranged. Preferably, the insulated compartment is fitted with an insulated cover. The casing may further includes a second insulated compartment separated from the first insulated compartment for storing chocolate.

Preferably, the second insulated compartment includes a vent and associated blower coupled to and controlled by the control system for moving ambient air through the second compartment in order to cool chocolate stored therein, and most preferably includes a temperature sensor electrically coupled to the control system and wherein control system activates the blower when the temperature sensor detects that a temperature in the second compartment is too high. The chocolate crafting system also may include a third compartment for storing chocolate crafting tools and other known chocolate crafting accessories. For that matter, the containers for holding and dispensing the chocolate are preferably squeeze bottles.

In an another embodiment, a portable chocolate crafting system is arranged as a casing configured with a plurality of semi-enclosed compartments that are open at the top for receiving and holding one of a plurality of containers arranged for holding and dispensing a quantity of chocolate. Each container of the plurality of containers includes an electrically-powered heating unit that electrically connects to an electrical connector disclosed within each respective semi-enclosed compartment upon placement of the container therein, which heating unit heats the container to heat, melt and maintain a quantity of chocolate contained therein in a molten, flowable state.

A control system or master controller that detects a presence of a container in a semi-enclosed heating compartment, detects a quantity of chocolate in the container, monitors a temperature of the chocolate in the container and controls an application of heat to the heating unit while the container is present in the semi-enclosed heating compartment based on a calculated chocolate state and a calculated temperature gradient of the chocolate.

### BRIEF DESCRIPTION OF THE DRAWINGS

The present invention can best be understood in connection with the accompanying drawings. It is noted that the invention is not limited to the precise embodiments shown in drawings, in which:

FIG. 1 depicts a front perspective elevational view of an integrated chocolate crafting system (10) of the present invention;

FIG. 1A is a front elevational detail view of one of the containers (50) for storing chocolate being treated and melted by the system (10) of FIG. 1;

FIGS. 1B and 1C are front perspective views of alternate embodiments with different sized programmable push button or touch screen keypads for individually controlling a plurality of storage compartment containers as in FIG. 1A;

FIG. 2 is a perspective view of an optional drawer (64) configured for containing a plurality of compartments for containing small amounts of molten chocolate that may include food dyes to define a variation in color from one to another compartment; which is configured to cooperate with the system (10) in FIG. 1;

FIG. 3 is a perspective partial cutaway view of one embodiment of a system (10) presented to highlight spirally wired electrical sleeves positioned in each of a plurality of respective chocolate warming compartments within the system (10); and

FIG. 4 is an electrical schematic depicting an electrical system (200) configured to operate within the integrated chocolate system (10) of the invention.

### DETAILED DESCRIPTION OF THE INVENTION

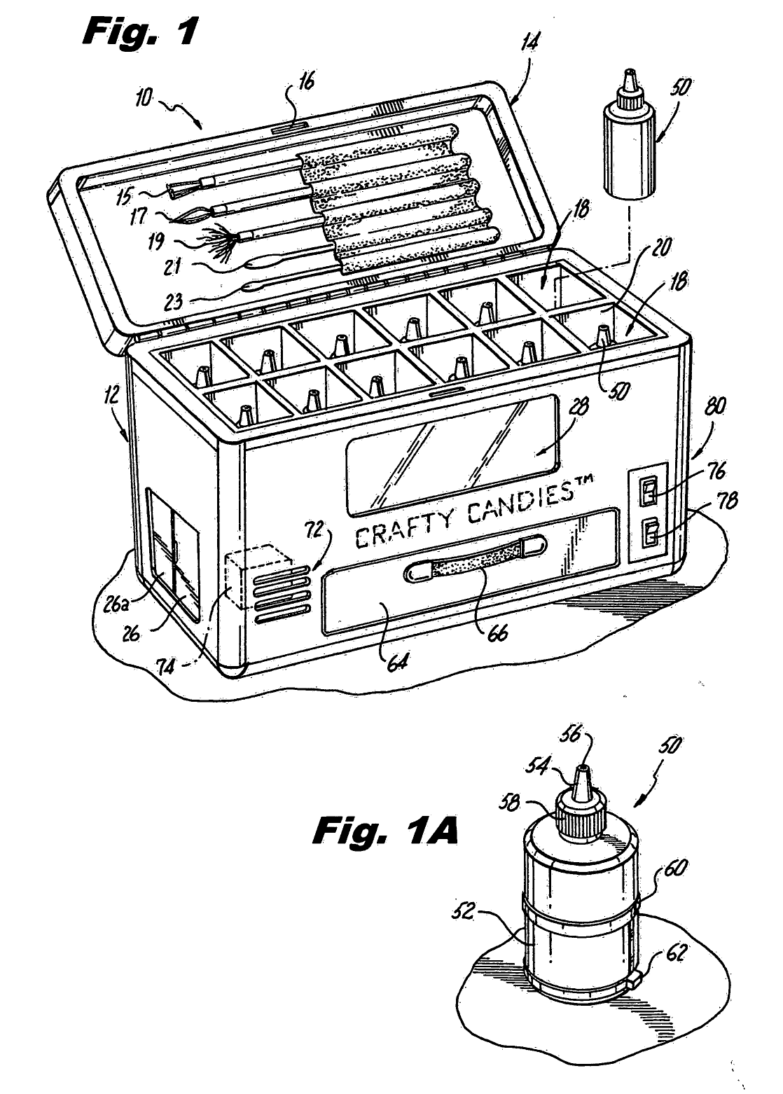

The following is a detailed description of example embodiments of the invention depicted in the accompanying drawings. The example embodiments are in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims. As shown in FIGS. 1-4, a portable chocolate crafting system (10) is arranged in or as a casing (12) comprising four sides, a bottom and a top or cover (14) securable to a front side (as shown) with a latch (16). In the casing (12) are arranged a plurality of semi-enclosed heating compartments (18). The semi-enclosed heating compartments (18) comprise separate volumes within the casing, which are open at a top end. The volumes may be cylindrical, cubical, rectangular, etc., defined by its base sides. The sides may be separated from other sides by an insert (20). Preferably, insert 20 is a single solid design comprising insulating material, with a thickness between 1 and 20 mm, which also forms a sub-base beneath the base of each of the semi-closed compartments (18). Alternatively, the insert itself may define the semi-closed compartment volume by defining the base and sides.

Each of the heating compartments is configured to receive and store one of a plurality of containers (50), shown in detail in FIG. 1A Containers (50) are for holding chocolate and liquid or flowable chocolate. Containers (50) are preferably formed of a biocompatible material, e.g. plastic, that will remain flexible and maintain its shape and resiliency in a temperature range between 0 and 75 degrees Centigrade.

The containers (50) comprise a base portion (52) that may be shaped cylindrically, cubically, rectangular, etc., in order to complement the shape of, or at least fit within the compartments (18) within the casing (12). A top (54) with a spout or small opening (56) releasably connects to the base (52) via a connecting portion or neck (58), which is preferably threaded. As an example, containers (50) may be squeeze bottles with flexible walls, or they may be any pourable and closable container.

In one embodiment, the semi-closed compartments (18) are arranged with heating units or elements (not shown in FIG. 1) for heating to melt and maintain chocolate within containers, preferably between 90 and 110 degrees Fahrenheit, and most preferably within 2 Fahrenheit degrees on either side of the chocolate melting point.

In an alternative embodiment, the heating units are not maintained in the compartments (18), but within containers (50). FIG. 1A shows an embodiment of a container (50) including a wire heating element (60) in the base portion (52), which heating element (60) extends to a connector (62). Connector (62), when connected to a voltage source via a complementary connector at the base of compartment (18), which is not shown in the drawing figures, supplies current to the wire heating element (60).

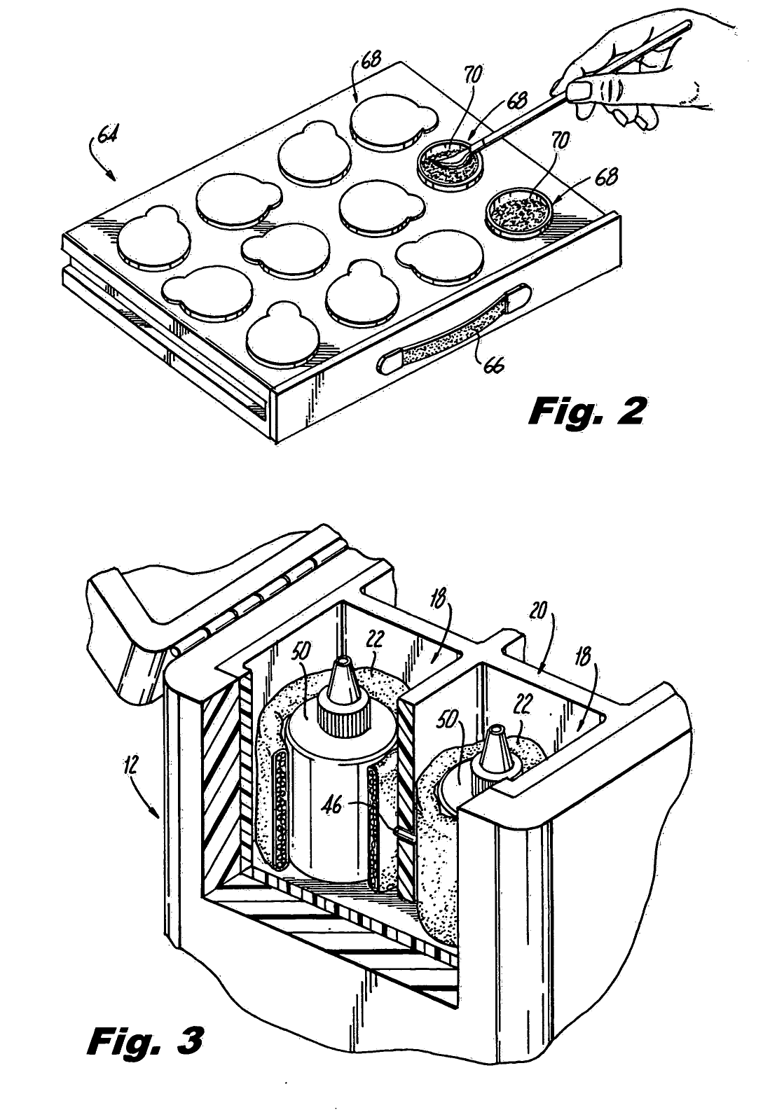

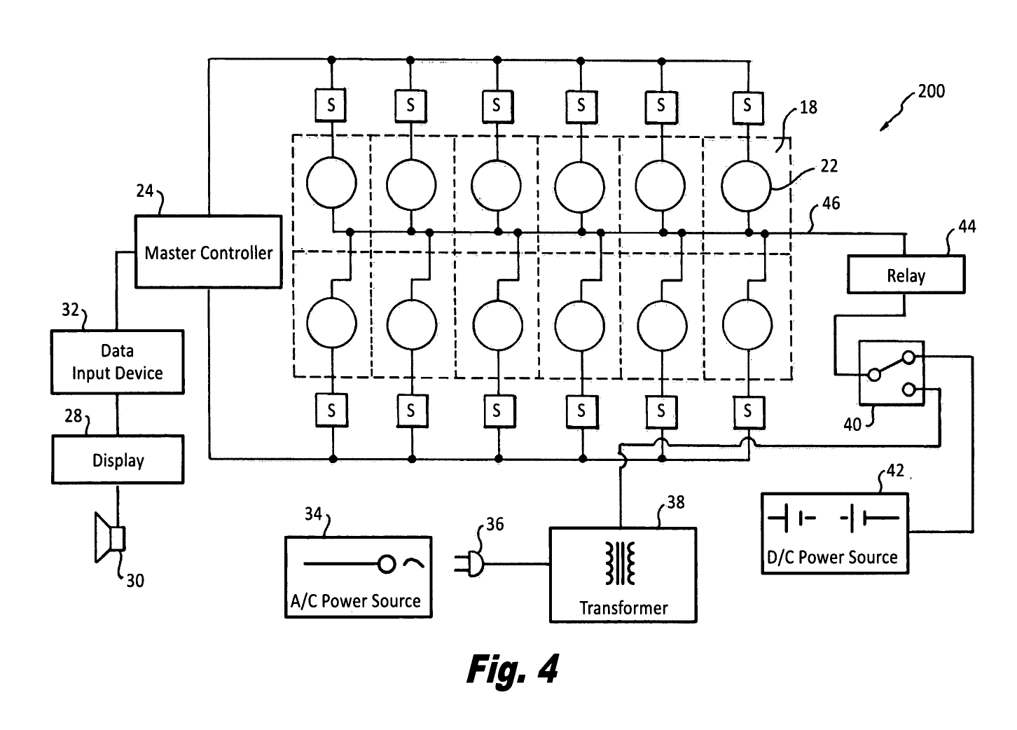

As shown in the electrical schematic diagrams of FIGS. 3 and 4, containers (50) are separately heated by a plurality of electrically-powered heating units (22). Each heating unit (22) is operatively arranged within each one of the plurality of heating compartments (18) to melt the quantity of chocolate contained in a user-selected container upon its positioning in the heating compartment. The heating element (22, 60) maintains the melted chocolate in a molten, flowable state. The heating units may comprise spirally wired sleeves, or may merely comprise conventional heating pads located at the base of compartment (18), or in the case of the alternative embodiment, the bottom of base portion (52) of container (50).

A control system or master controller (24) controls operation of the chocolate crafting system (10). Master controller (24) in cooperation with a sensor detects a presence of a container (50) in a heating compartment (18), optionally detects a quantity of chocolate in the container (50) using a weight sensor (not expressly shown), monitors a temperature of the chocolate in the container using a temperature sensor (S). The control system or master controller (24) further includes a timer for maintaining a time during which heat is applied to each heating unit within each compartment within which a container is present, or to the heating unit in the container.

The master controller stores and maintains a record of temperatures and weights over time, so can detect a temperature gradient over time for a chocolate mass that is moving up to the melting point, moving down from the melting point, moving up from the melting point, or moving down towards the melting point. As such, the master controller may indicate a physical state of the chocolate in a container (50) via a display (28) or an alarm (30). A user might then take action to address the changing condition, for example, placing a container in hand back into a compartment and to the source of heat or electrical current, as the case may be, to keep the chocolate from changing state. A data input device (32), such as a key board, cooperates with the master controller and display to allow data input, and programming of the system (10).

As shown in FIG. 4, the chocolate crafting system (10) may be connected to an AC source (34) via connector (36), by which AC power is passed to and transformed in transformer (38), in a case where the heating units (22, 60) are AC driven. An AC-DC converter (not shown), would then convert AC to the system's DC needs, as known to the skilled artisan. The electrical power system or path from AC source (34) preferably includes a two way switch (40) to alternately power the system from a low voltage DC power source (42), such as a battery or plurality of batteries, or from transformer (38). An optional relay (44) electrically operates in cooperation the two-way switch (40).

The casing (12) or box enclosing the chocolate crafting system includes a first insulated compartment, within which the plurality of heating compartments (18) is arranged. The outer and base portions of insert (20) sit within the first insulated compartment. The wiring (46) supplying current to the heating units (22, 60) pass into the first compartment and the heating compartments (18) therein. The insulated compartment is preferably fitted with an insulated cover, for example, fitted into an inner side of casing top (14).

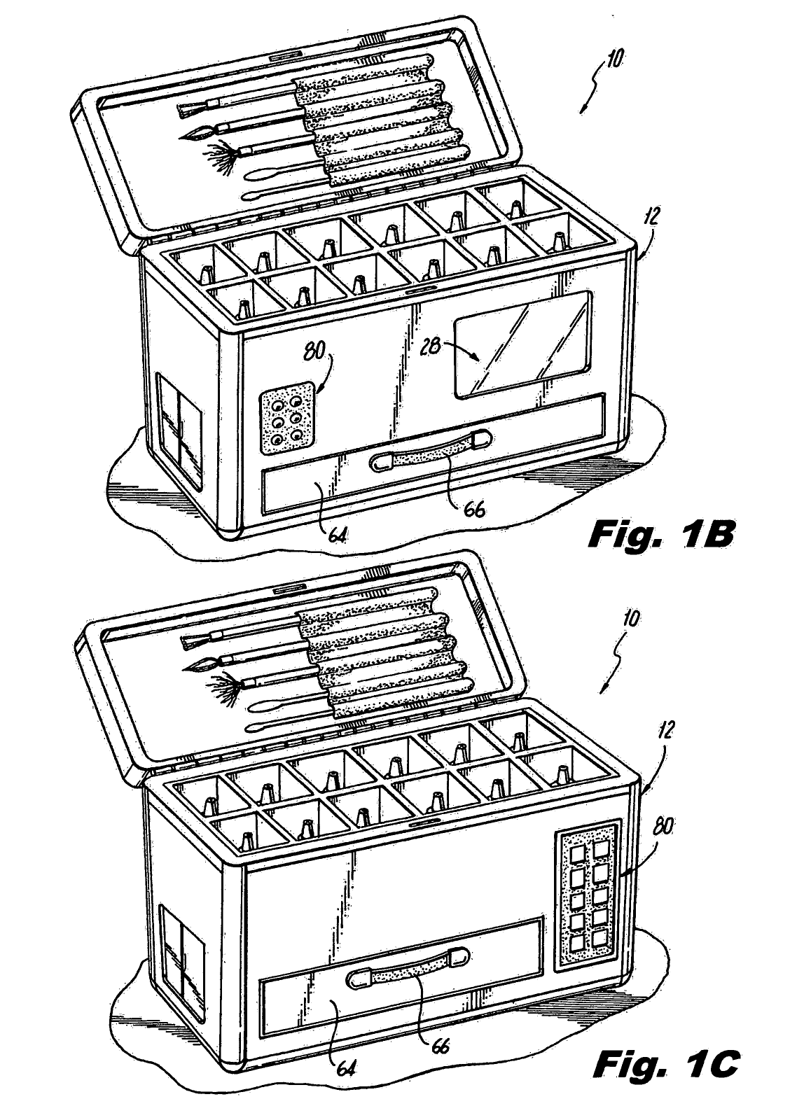

The casing (12) preferably includes a second insulated compartment that is separated from the first insulated compartment, for storing chocolate. The second insulated compartment may take a form of a drawer (64) that is opened and closed by a handle (66). In the FIG. 2 embodiment, the drawer (64) for placement in the second insulated compartment includes a number of separate storage compartments including chocolate- or other material-holding portions (70). Preferably, drawer (64) is configured with a plurality of compartments for containing small amounts of molten chocolate. The molten or liquid chocolate may include food dyes, which define a variation in color from one to another compartment. As such, the drawer operates as chocolate painter's palette, allowing a user to grasp it or place it near his/her work, and brush or otherwise apply the colored chocolate (or other liquid confection) for detailing purposes.

The second compartment preferably includes a vent (72) and associated blower (74) coupled to and controlled by the control system or master controller (24). The vent (72) and blower (74) cooperate to move ambient air through the second compartment when necessary to cool chocolate stored therein. The second compartment further includes a temperature sensor electrically coupled to the control system (24). The control system activates the blower when the temperature sensor detects that a temperature in the second compartment is too high, the internal temperature of the casing is too high and where the temperature is too low such that the chocolate in the compartments therein are at risk of solidifying. Alternatively, the drawer (64) may have at least one temperature sensor disposed proximate at least one of the small compartments, and preferably some type of audible or visible alarm device attached thereto in order to notify the user that the drawer, or the chocolate in at least one compartment is cooling to a point where, if not heated shortly, will solidify.

Optionally the chocolate crafting system includes a third compartment, for example, a side compartment (26) into which, for example, pop sticks, twist ties, cellophane bag, bag holders, etc., may be stored. Preferably, the chocolate crafting system includes a compartment for storing and accessing chocolate crafting tools. In an embodiment, this tool storage compartment may be maintained in the top cover (14), or in drawer (64). The tool compartment can include a flat chocolate brush (15), a pointed chocolate brush (17), a fan brush (19) and molding tool (21) and a small tip molding tool (23), as shown in FIG. 1, without limitation.

Third compartment (26) may also be divided into a fourth compartment (26a) for storage of edible accessories, such as chocolate chips, sprinkles and/or toppings. For sanitary reasons it is isolated from third compartment (26) with the hand tools.

The master controller or control system (24) preferably includes a microcontroller and associated memory having a set of computer readable instructions that are stored in the memory that when operated upon by the microcontroller implements a plurality of functions required to operate the aforementioned features. The program may be downloaded via an input port (not shown), or stored in an attached computer readable medium. Various switches (76, 78, 80) may be included on the face of the device to override the microcontroller control, turn power on/off/turn on optional lighting, etc.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

What is claimed is:

1. A chocolate crafting system, comprising:
a casing configured with a plurality of semi-enclosed heating compartments that are open at the top for receiving and holding one of a plurality of containers, the containers arranged for holding and dispensing a quantity of chocolate;
a plurality of electrically-powered heating units operatively arranged within each one of the plurality of semi-enclosed heating compartments, which heating units heat the compartments thereby heating the containers positioned therein in order to heat, melt and maintain the quantity of chocolate in each container in a molten, flowable state; and
a control system that detects a presence of a container in a semi-enclosed heating compartment, detects a quantity of chocolate in the container, monitors a temperature of the chocolate in the container and controls an application of heat to the heating unit at the semi-enclosed heating compartment in which the detected container is present based on a calculated chocolate state and its detected temperature gradient.

2. The chocolate crafting system as set forth in claim 1, wherein the semi-enclosed compartments further comprise:
a sensor located therein for sensing the presence of a container therein; and
a temperature sensor located therein for sensing a temperature of detected chocolate present in the container.

3. The chocolate crafting system as set forth in claim 2, wherein the heating units further comprise a weight sensor located at each semi-enclosed heating compartment for detecting an amount of chocolate in a container therein.

4. The chocolate crafting system as set forth in claim 3, wherein the control system further comprises a timer for tracking a time during which heat is applied to each heating unit within each semi-enclosed heating compartment within which a container is present.

5. The chocolate crafting system as set forth in claim 4, wherein the control system, based on a detected weight and temperature of chocolate in a container, controls an amount of electrical power delivered to the associated heating unit.

6. The chocolate crafting system as set forth in claim 5, wherein the control system maintains a record of detected temperatures and weights of chocolate present in the container over time, calculates a temperature gradient based thereon, and controls an amount of electrical power delivered to the associated heating unit to either effectively melt the chocolate or, if already in a melted state, to effectively maintain the chocolate in said melted state.

7. The chocolate crafting system as set forth in claim 1, further comprising a display and an input device, wherein the control system comprises a microcontroller and a memory-storage device and wherein the memory-storage device comprises a set of computer readable instructions that are operated upon by the microcontroller to implement a plurality of control functions.

8. The chocolate crafting system as set forth in claim 1, wherein the semi-enclosed heating compartments are heat-insulated from one another.

9. The chocolate crafting system as set forth in claim 1, wherein the control system controls an alarm signal output in response to detecting 1) that chocolate in a container is too hot and 2) that an amount of chocolate in a container is less than a recommended amount.

10. The chocolate crafting system as set forth in claim 1, further comprising an electrical power source for powering the control system and heating units.

11. The chocolate crafting system as set forth in claim 10, wherein the electrical power source is a DC battery pack.

12. The chocolate crafting system as set forth in claim 1, wherein the casing comprises a first insulated compartment within which the plurality of semi-enclosed heating compartments are arranged.

13. The chocolate crafting system as set forth in claim 12, wherein the insulated compartment is fitted with an insulated cover.

14. The chocolate crafting system as set forth in claim 12, wherein the casing comprises a second insulated compartment separated from the first insulated compartment including a plurality of sections configured for storing small amounts of chocolate, which may be colored for use in detailing.

15. The chocolate crafting system as set forth in claim 14, wherein the second insulated compartment includes a vent and associated blower coupled to and controlled by the control system for moving ambient air through the second compartment in order to cool chocolate stored therein.

16. The chocolate crafting system as set forth in claim 14, wherein the second compartment further comprises a temperature sensor electrically coupled to the control system and wherein control system activates the blower when the temperature sensor detects that a temperature in the second compartment is too high.

17. The chocolate crafting system as set forth in claim 1, further comprising a third compartment for storing chocolate crafting tools.

18. The chocolate crafting system as set forth in claim 1, wherein the containers comprise squeeze bottles.

19. The chocolate crafting system as set forth in claim 1, wherein the control system comprises a microcontroller and associated memory comprising a set of computer readable instructions that when operated upon by the microcontroller implement a plurality of functions.

20. A chocolate crafting system, comprising:
a casing configured with a plurality of semi-enclosed compartments that are open at the top for receiving and holding one of a plurality of containers arranged for holding and dispensing a quantity of chocolate,
wherein each container of the plurality of containers includes an electrically-powered heating unit that electrically connects to an electrical connector disclosed within a respective compartment upon placement of the container therein, which heating unit heats the container to heat, melt and maintain a quantity of chocolate contained therein in a molten, flowable state; and
a control system that detects a presence of a container in a semi-enclosed compartment, detects a quantity of chocolate in the container, monitors a temperature of the chocolate in the container and controls an application of heat to the container heating unit while the container is present in the semi-enclosed heating compartment and electrically connected to the control system based on a calculated chocolate state and a calculated temperature gradient.
